(19) United States
(12) Patent Application Publication
(10) Pub. No.: US 2010/0101062 A1
(43) Pub. Date: Apr. 29, 2010

(54) COMBINATION STRUCTURE OF AN URN FOR PETS' CREMATE REMAINS

(76) Inventors: Shen Chin CHEN, Douliou (TW); Jin Huei Chan, Douliou (TW); Chin Lung Lee, Douliou (TW)

Correspondence Address: SINORICA, LLC, 2275 Research Blvd., Suite 500, ROCKVILLE, MD, 20850, US

(21) Appl. No.: 12/533,116

(22) Filed: Jul. 31, 2009

(30) Foreign Application Priority Data
Oct. 24, 2008 (TW) 097218991

(51) Int. Cl. A61G 17/00

(52) U.S. Cl. 27/1

(57) ABSTRACT

A combination structure of a cinerary urn comprises an inner jug, an outer jug and locking keys. The outer jug can be separated. The inner jug can be put into the separated outer jug and the separated outer jug can be closed by means of several locking keys so as to achieve the object of easily getting access to and encapsulating the bone ash.

### BACKGROUND OF THE INVENTION

1. Technical Field

A combination structure of a cinerary urn comprises an inner jug, an outer jug and locking keys. The outer jug can be separated. The inner jug can be put into the separated outer jug and the separated outer jug can be closed by means of several locking keys so as to achieve the object of easily getting access to and encapsulating the bone ash.

2. Description of the Related Art

Cinerary/bone ash urns are well-known in prior art, and typically have a lid, a jug body and an inner jug. The main purposes of the structure of the known cinerary urns are to keep the cinerary urns from being humidified, fire, separating, falling on the ground due to accidents such as earthquake.

For example, Taiwan utility model patent No. 304331, entitled “improved structure of cinerary urn,” discloses a cinerary urn has an inner jug and an outer jug is made of glass fiber material so as to prevent the jug body from breaking. However, there is not any effort to keep the bone ash from being humidified or to easily get access to the bone ash.

Further, Taiwan utility model patent No. 284370, entitled “combination structure of cinerary urn,” discloses a cinerary urn has an inner jug. A flange on a lid of the inner jug is used to be snapped with protrusions and snapping supporters on the inner wall of the inner jug so as to seal the inner jug and to prevent the inner jug from being separated. However, it is laborious to close or open the inner jug, and it is not easy to get access to the bone ash.

Still further, Taiwan utility model patent No. 279335, entitled “improved structure of cinerary urn,” discloses a cinerary urn has an outer jug, an outer lid, an inner jug and an inner lid. The inner lid has a plurality of uneven bend flanges to serve as shock absorbers. The inner lip is laterally rotated to be firmly attached to the inner jug by mean of slope so as to seal the inner jug and to prevent the inner jug from being separated. However, it is laborious to close or open the inner jug, and it is not easy to get access to the bone ash.

### SUMMARY OF THE INVENTION

With the trend of few-children and aged society, more and more people treat pets as one member of their family member. The raisers of those pets have a deep relationship with their pets. Particularly, a lot of people have pets, but the lifetime of the pets is most likely shorter than that of their raisers. The situation of the aged population structure is getting severe more and more. For sustainable development of the earth for the future of our progeny, the existing requirement of the environment protection is getting severe more and more. Therefore, cremation is the first consideration for the dead body of humans or pets.

Founding on piety and love, people usually keep the bone ash of the forerunners or the pets, and elaborate on completely protecting and preserving the bone ash of the forerunners and the pets. In order to keep the treasured affect and relationship between the pets and the raisers in the long term, there is a present need to provide a device for safely and closely keeping the bone ash which is meaningful to those raisers and those progeny.

The first object of the present invention is to provide a cinerary urn comprising a bone ash jug left portion, a bone ash jug right portion, and a bone ash inner jug. The bone ash jug left portion comprises a bone ash jug room and magnet rods. The bone ash jug right portion comprises a bone ash jug room and magnet bars. The bone ash inner jug comprises an inner jug left portion and an inner jug right portion which are engaged with each other by threads. The magnet rods of the bone ash jug left portion and the magnet bars of the bone ash jug right portion are attracted by each other so as to easily close the cinerary urn

The second object of the present invention is to provide the cinerary urn in which one of the magnet rod and the magnet bar is replaced by one of an iron plate and a steel plate.

The third object of the present invention is to provide the cinerary urn comprising a bone ash jug left portion, a bone ash jug right portion, and a bone ash inner jug. The bone ash jug left portion comprises a bone ash jug room and magnet rods. The bone ash jug right portion comprises a bone ash jug room and locking components each having a same polarity magnet bar and a different polarity magnet bar. The bone ash inner jug comprises an inner jug left portion and an inner jug right portion which are engaged with each other by threads. The different polarity magnet bar of the locking component of the bone ash jug right portion and the magnet rods of the bone ash jug left portion are attracted by each other so as to easily close the cinerary urn.

The fourth object of the present invention is to provide the cinerary urn in which the same polarity magnet bar and the different polarity magnet bar of the locking component are capable of moving up and down.

The fifth object of the present invention is to provide the cinerary urn in which the same polarity magnet bar and the different polarity magnet bar of the locking component are capable of rotation.

The sixth object of the present invention is to provide the cinerary urn in which the same polarity magnet bar of the locking component is made of non-ferromagnetic materials.

Due to the drawbacks in prior art and the need in the modern society, the present invention provides a cinerary urn for sealing the bone ash as well as for easily getting access to the bone ash. The invention may best be understood by reference to the following description of the presently preferred embodiments together with the accompanying drawings.

### BRIEF DESCRIPTION OF THE DRAWINGS

FIG. 1 is a schematic exploded perspective view showing a cinerary urn according to an embodiment of the present invention.

FIG. 2 is a schematic partially-sectional perspective view showing a cinerary urn according to an embodiment of the present invention.

FIG. 2-1 is another schematic partially-sectional perspective view showing a cinerary urn according to an embodiment of the present invention.

FIG. 3 is a schematic exploded perspective view showing a locking component according to an embodiment of the present invention in detail.

FIG. 4 is a schematic exploded perspective view showing another locking component according to another embodiment of the present invention in detail.

### DETAILED DESCRIPTION OF THE INVENTION

### Embodiment 1

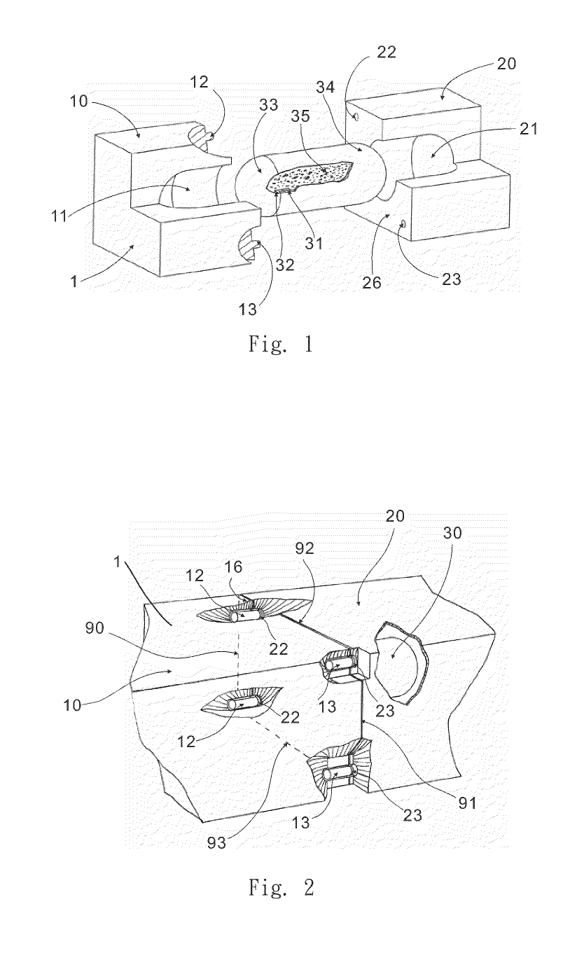

Referring to FIG. 1, a cinerary/bone ash urn according to the present invention comprises a bone ash inner jug, a bone ash jug and locking structure. The bone ash inner jug 30 is made of plastic material, such PE, PP, ABS, PS, PC, fireproof plastic material, and so on, and comprises a bone ash inner jug right portion 34 and a bone ash inner jug left portion 33. The bone ash inner jug right portion 34 and the bone ash inner jug left portion 33 both are capsule-like in shape, and comprise bone ash cavity 35 for receiving bone ash 32. The bone ash inner jug right portion 34 is longer than the bone ash inner jug left portion 33 and has an external thread 31 so as to be engaged with an internal thread 35 of the bone ash inner jug left portion 33 and then to encapsulate the bone ash 32. The bone ash inner jug right portion 34 and the bone ash inner jug left portion 33 can be engaged with each other by snapping.

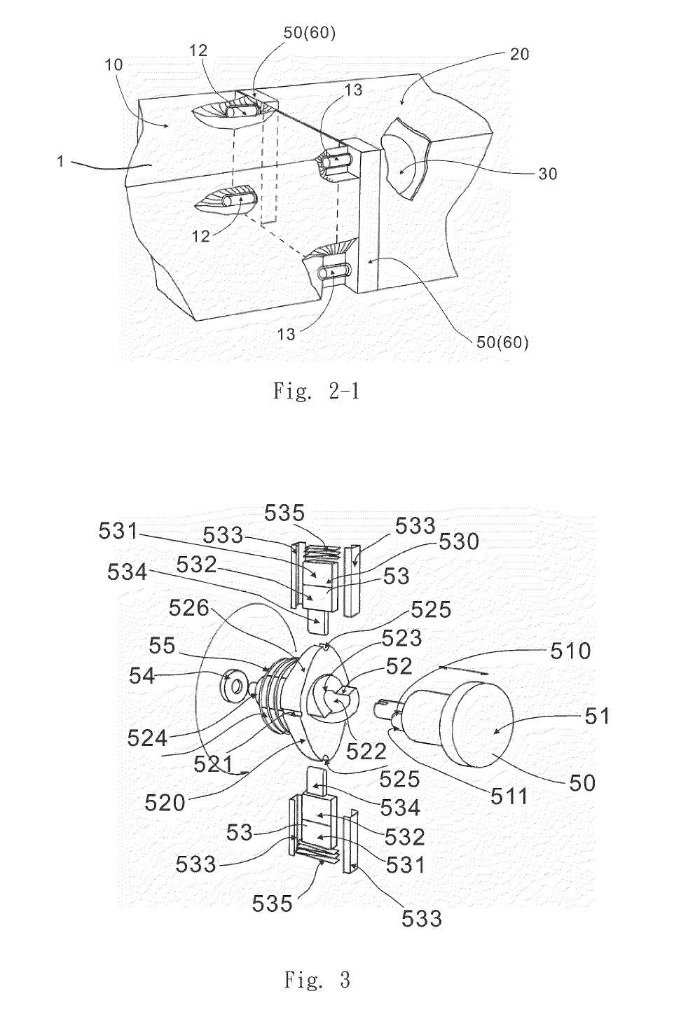

Referring to FIG. 1 and FIG. 2, the bone ash jug 1 according to the present invention comprises a bone ash jug left portion 10 and a bone ash jug right portion 20. The bone ash jug left portion 10 and the bone ash jug right portion 20 respectively have a bone ash jug left room 11 and a bone ash jug right room 21 for receiving the bone ash inner jug 30 which encapsulates the bone ash 35. In addition, the rear end 16 of the bone ash jug left portion 10 have a pair of right magnet rods 12 with exposed cathodes and a pair of left magnet rods 13 with exposed cathodes, which are located on the both sides of the rear end 16 of the bone ash jug left portion 10. The front end 26 of the bone ash jug left portion 20 have a pair of left magnet bars 22 with exposed anodes and a pair of right magnet bars 23 with exposed anodes, which are located on the both sides of the front end 26 of the bone ash jug right portion 20 corresponding to the right and left magnet rods 12 and 13.

Then, the bone ash inner jug 30 which is in capsulate-like shape and contains the bone ash 32 is put into the bone ash jug right room 21 of the bone ash jug right portion 20. Moreover, the right and left magnet rods 12 and 13 with the exposed cathodes which is located near the four corners of the rear end 16 of the bone ash jug left portion 10 will be moved or approached to the left and right magnet bars 22 and 23 with the exposed anodes which is located near the four corners of the front end 26 of the bone ash jug left portion 20. The magnetic forces between the left and right magnet bars 22 and 23 with the exposed anodes and the right and left magnet rods 12 and 13 with the exposed cathodes will force the bone ash jug left portion 10 and the bone ash jug left portion 20 to be firmly attached to each other.

When the cinerary urn 1 needs to be opened, the bone ash jug left portion 10 and the bone ash jug right portion 20 need to be pivoted in relation to each other on the rear combination line 90 in horizontal direction so as to separate the front combination line 91 of the bone ash jug 1. Then, the angle between the bone ash jug left portion 10 and the bone ash jug right portion 20 on the axis of the rear combination line 90 is increased, and the bone ash jug left portion 10 and the bone ash jug right portion 20 will be separated such that the inner jug 30 can be put into or took out from the bone ash jug 1.

Further, the bone ash jug 1 also can be opened on the axis of the front combination line 91, and the similar method can be used to open the bone ash jug 1 on the axis of an upper combination line 92 or a lower combination line 93. In addition, ferromagnetic materials can be used in place of the magnet bars 22 and 23 with the exposed anodes or the magnet rods 12 and 13 with the exposed cathodes, and only one side is kept the same and the other is replaced with ferromagnetic materials, such as iron plates or steel plates.

### Embodiment 2

Referring to FIG. 2-1 and FIG. 3, two locking component 50 are installed on the both sides of the bone ash jug right portion 20 corresponding to the right magnet rods 12 and the left magnet rods 13 on the four corners of the rear end 16 of the bone ash jug left portion 10. The locking component 50 comprises a pressing bottom 51, a rotator 52, locking control blocks 53, a component supporter 54, and a compression spring 55. The rotator 52 comprises a receiving hole 522 and a rotating rod 524. The locking control block 53 comprises a controller guiding rod 534, an open and close controller 530, a plate compression spring 535 and internal grooves 533.

The compression spring 55 is horizontally put on the rotating rod 524 of the rotator 52, and the rotating rod 524 of the rotator 52 is put into the component supporter 54. Further, a pressing bottom shaft 510 of the pressing bottom 51 is installed into the receiving 522 of the rotator 52, and then the pair of the locking control blocks 53 is located above and below the rotator 52.

When the bone ash jug 1 need to be opened, the pressing bottom 51 will be pressed and a protrusion 511 located on the front of the pressing bottom 51 will contact a slant 523 of the rotator 52 such that a torque generated by the horizontal force between the pressing bottom 51 and the slant 523 rotates the rotator 52. A tongue 520 of the rotator 52 is rotated following the rotation of the rotator 52 so as to push the controller guiding rod 534 out of a positioning trough 525 of the tongue 520. Then, the controller guiding rod 534 slides alone by a curved slant 526 until the controller guiding rod 534 is moved to a positioning trough 521 of the tongue 520. At the same time, the compression spring 55 located between the rotator 52 and the component supporter 54 horizontally pushes the rotator 52 and the pressing bottom 51 back to the original location after the rotator 52 is rotated by 90 degrees. When the controller guiding rod 534 is in the positioning trough 521 of the tongue 520, the open and close controllers 530 of the locking control blocks 53 will be move up and down due to the spring force of the plate compression spring 535 and due to the gap between the tongue 520 and the positioning trough 521, and then will be located in a lower position. A positive magnet plate 531 and a negative magnet plate 532 of the open and close controllers 530 is moved downward in the internal grooves 533 such that the negative magnet plate 532 of the open and close controllers 530 is positioned corresponding to the right and left magnet rods 12 and 13 with the exposed cathodes around the four corners of the rear end 16 of the bone ash jug left portion 10.

In this case, the magnetic repulsive force between the same polarities separates the bone ash jug left portion 10 and the bone ash jug right portion 20 so as to open the bone ash jug 1.

When the bone ash jug 1 need to be closed, the controller guiding rod 534 in the positioning trough 525 of the tongue 520 is pushed outward and slides alone by the curved slant 526 of the tongue 520 until the controller guiding rod 534 is moved to the lower position in the positioning trough 521 of the tongue 520. The pressing bottom 51 is pressed again, the above mentioned movement will be repeated and the controller guiding rod 534 in the positioning trough 521 of the tongue 520 is pushed upward and slides alone by the curved slant 526 of the tongue 520 until the controller guiding rod 534 is moved to the higher position in the positioning trough 525 of the tongue 520. The positive magnet plate 531 and the negative magnet plate 532 of the open and close controllers 530 is moved upward in the internal grooves 533 such that the positive magnet plate 532 of the open and close controllers 530 is positioned corresponding to the right and left magnet rods 12 and 13 with the exposed cathodes around the four corners of the rear end 16 of the bone ash jug left portion 10.

In this case, the magnetic attractive force between the different polarities combines the bone ash jug left portion 10 and the bone ash jug right portion 20 together so as to close the bone ash jug 1. Further, the negative magnet plate 532 of the open and close controllers 530 can be replaced by the non-ferromagnetic materials, such as plastic materials, non-ferrous metal materials, and so on.

### Embodiment 3

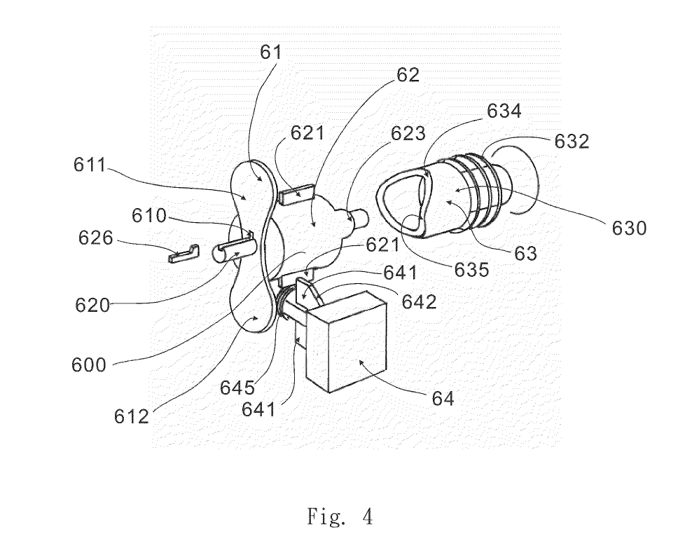

Referring to FIG. 2-1 and FIG. 4, two locking component 60 according to another embodiment of the present invention are installed on both sides of the bone ash jug right portion 20 corresponding to the right and left magnet rods 12 and 13 with the exposed cathodes around the four corners of the rear end 16 of the bone ash jug left portion 10. The locking component 60 comprises a pressing key 64, a rotating switch shaft 62, a close controller paddle 61, and a curved transfer supporter 63. The pressing key 64 comprises a key 640 and a rear compression spring 645. The curved transfer supporter 63 comprises an arc switch supporter 630 and a back compression spring 632.

The close controller paddle 61 is installed on a front core shaft 620 of the rotating switch shaft 62, and a stop key 626 is inserted into the front core shaft 620 and a key way 610 of the close controller paddle 61 so as to keep the close controller paddle 61 from rotating in relation to the switch shaft 62. Then, the curved transfer supporter 63 is attached to the rotating switch shaft 62 from the rear side of the rotating switch shaft 62, and the pressing key 64 is laterally installed to the locking component assembly 600.

When the bone ash jug 1 need to be opened, the pressing key 64 will be pressed frontward such that two fin protrusions 641 on the upper and the lower sides of the shaft body 644 of the pressing key 64 is moved against a fin 621 of the rotating switch shaft 62 to push forward the rotating switch shaft 62. An arc protrusion 622 installed on the rear portion of the rotating switch shaft 62 has an arc slant 623 which is against the curved transfer supporter 63, rises alone by a curved slant 634 of the curved transfer supporter 63 through a high point 631 of the curved transfer supporter 63, and falls to a low point 635. As thus, the curved transfer supporter 63 is rotated by 180 degrees and a positive magnet bar 611 (also known as a different polarity magnet bar) is rotated to the downside and a negative magnet bar 612 (also known as a same polarity magnet bar) is rotated to the upside, the position of which is corresponding to the right and left magnet rods 12 and 13 with the exposed cathodes around the four corners of the rear end 16 of the bone ash jug left portion 10, so as to generate the magnetic repulsive force between the same polarities and to open the bone ash jug 1.

When the pressing key 64 is released, the spring force of the rear compression spring 645 will push the pressing key 64 back to the original position through a guiding slope 642 of the fin protrusions 641

When the bone ash jug 1 need to be closed, only the pressing key 64 need to be pressed again and the curved transfer supporter 63 rotates as the way mentioned above such that the positive magnet bar 611 is rotated to the upside and the negative magnet bar 612 is rotated to the downside, the position of which is corresponding to the right and left magnet rods 12 and 13 with the exposed cathodes around the four corners of the rear end 16 of the bone ash jug left portion 10. The magnetic attractive force between the different polarities is generated and the bone ash jug 1 is closed. The negative magnet bar 612 on the close controller paddle 61 can be replaced by the non-ferromagnetic materials, such as plastic materials, non-ferrous metal materials, and so on.

What is claimed is:

1. A cinerary urn, comprising:
a bone ash jug left portion comprising a bone ash jug room and magnet rods;
a bone ash jug right portion comprising a bone ash jug room and magnet bars; and
a bone ash inner jug comprising an inner jug left portion and an inner jug right portion which are engaged with each other by threads,
wherein the magnet rods of the bone ash jug left portion and the magnet bars of the bone ash jug right portion are attracted by each other so as to easily close the cinerary urn.

2. The cinerary urn as claimed in claim 1, wherein one of the magnet rod and the magnet bar is replaced by one of an iron plate and a steel plate.

3. A cinerary urn, comprising:
a bone ash jug left portion comprising a bone ash jug room and magnet rods;
a bone ash jug right portion comprising a bone ash jug room and locking components each having a same polarity magnet bar and a different polarity magnet bar; and
a bone ash inner jug comprising an inner jug left portion and an inner jug right portion which are engaged with each other by threads,
wherein the different polarity magnet bar of the locking component of the bone ash jug right portion and the magnet rods of the bone ash jug left portion are attracted by each other so as to easily close the cinerary urn.

4. The cinerary urn as claimed in claim 3, wherein the same polarity magnet bar and the different polarity magnet bar of the locking component are capable of moving up and down.

5. The cinerary urn as claimed in claim 3, wherein the same polarity magnet bar and the different polarity magnet bar of the locking component are capable of rotation.

6. The cinerary urn as claimed in claim 3, wherein the same polarity magnet bar of the locking component is made of non-ferromagnetic materials.
